(19) United States
(12) Patent Application Publication
(10) Pub. No.: US 2022/0012469 A1
(43) Pub. Date: Jan. 13, 2022

(54) METHOD FOR SHARING INFORMATION FOR IDENTIFYING A PERSON OR OBJECT

(71) Applicants: Wojciech KUCHARSKI, Jaworzno (PL); Pawel NIEMIEC, Rzeszów (PL); Bogdan STEPIEN, Kraków (PL); Lee M. PROCTOR, Cary, IL (US); MOTOROLA SOLUTIONS, INC., CHICAGO, IL (US)

(72) Inventors: WOJCIECH KUCHARSKI, JAWORZNO (PL); PAWEL NIEMIEC, RZESZOW (PL); BOGDAN STEPIEN, SANDY, UT (US); LEE PROCTOR, CARY, IL (US)

(21) Appl. No.: 17/295,899

(22) PCT Filed: Mar. 29, 2019
(86) PCT No.: PCT/PL2019/050019

§ 371 Date: May 21, 2021

(51) Int. Cl. G06K 9/00

(52) U.S. Cl. CPC G06K 9/00255; G06K 9/00288; G06K 9/00744

(57) ABSTRACT

A method and apparatus for sharing information used to identify an object/person by a camera (e.g., a body-worn camera) is provided herein. During operation the apparatus will determine a set of characteristics that can be used to identify the object/person. The apparatus then analyzes the body-worn camera's FOV (or potential FOV) and removes characteristics from the set of characteristics to produce a minimal set of characteristics that can be used to identify the object/person in the body-worn cameras FOV. The minimal set of characteristics is then sent to the officer's body-worn camera for detection.

### BACKGROUND OF THE INVENTION

Many times a public-safety officer utilizes technology designed to identify a person or object in a crowded field of view (FOV). For example, many times officers look for wanted persons in a crowd, or look for objects in a crowd that may pose a danger. Body-worn cameras may aide in identifying such persons or objects. More particularly, information on objects/persons may be provided to a body-worn camera, with the body-worn camera aiding in identifying the objects/persons by warning the officer when the object/person is detected by the camera.

For many reasons, it is beneficial to provide the body-worn camera with a minimal amount of information that can be used to identify a person or object. For example, body-worn cameras may not have the processing power to quickly perform complex, real-time facial recognition in a manner that centralized computers do. Therefore, if a body-worn camera can quickly identify an individual by simpler means using less information, it will be beneficial to do so. Because of this, would be beneficial to provide a minimal amount of information to the body-worn camera so that the body-worn camera can identify the object/person in a quick and effective manner.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates a general operational environment for a public-safety officer.

FIG. 2 is a block diagram of the server of FIG. 1.

FIG. 3 is a block diagram of a camera that may be used to provide a minimal set of characteristics to another camera or person in order to identify a person or object.

FIG. 4 is a flow chart showing operation of the server of FIG. 2 and the camera of FIG. 3.

FIG. 5 is a flow chart showing operation of the apparatus of FIG. 3 performing an audible notification of a minimal set of characteristics.

FIG. 6. is a flow chart showing operation of the apparatus of FIG. 3 performing an audible notification of a minimal set of characteristics.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above, a method and apparatus for sharing information used to identify an object/person by a camera (e.g., a body-worn camera) is provided herein. During operation the apparatus will determine a set of characteristics that can be used to identify the object/person. The apparatus then analyzes the body-worn camera's FOV (or potential FOV) and removes characteristics from the set of characteristics to produce a minimal set of characteristics that can be used to identify the object/person in the body-worn cameras FOV. The minimal set of characteristics is then sent to the officer's body-worn camera for detection.

Consider the following example: A person is recognized to be potentially dangerous (e.g., dangerous behavior, wearing a weapon, . . . , etc.) by a surveillance camera. The surveillance camera determines a set of characteristics that can be used to identify the potentially-dangerous person. The set of characteristics may comprise characteristics such as, but not limited to like information clothes, posture, skin color, hair color style, gender, age, facial-recognition parameters, . . . , etc. The surveillance camera then determines a minimal set of characteristics that the body-worn camera can use to uniquely identify the potentially-dangerous person. The surveillance camera shares the minimal set of characteristics with the body-worn camera.

In the above example, the surveillance camera determined a full set of characteristics that can be used to identify the potentially-dangerous person, however in an alternate embodiment of the present invention, the surveillance camera may be provided the full set of characteristics from another source (for example, a dispatch center or server). The other source may then determine the minimal set of characteristics that can be used by the body-worn camera to identify the person or object.

As is evident, the process of determining the full set of characteristics and determining the minimal set of characteristics may take place at the edge (within a video camera) or take place in centralized equipment (e.g., in a server/dispatch center).

It is obvious that the apparatus determining the minimal set of characteristics necessary for a body-worn camera to identify an object/person will need to know what the body-worn camera “sees”, or has the potential of “seeing” in order to determine the minimal set of characteristics. For example, if the body-worn camera “sees” only a one individual wearing a lime-green shirt, then the color of the shirt may be the only characteristic that the body-worn camera will need to be provided in order to identify the individual. Similarly, if both a male and female are wearing lime-green shirts, then the gender and shirt color may be the only characteristics that the body-worn camera will need to be provided in order to identify the individual.

What the body-worn camera sees, or has the potential of seeing is determined from what exists (or has the potential of existing) within the FOV of the body-worn camera. The FOV of the body-worn camera may be determined by several means. In a first embodiment of the present invention, an image (or video) from the body-worn camera may be provided to a remote apparatus, and the minimal set of characteristics may be determined by the apparatus by analyzing the image obtained from the body-worn camera.

In a second embodiment, the remote apparatus may comprise a camera, and the camera may be somewhat co-located with the officer's body-worn camera. (Two cameras are “co-located” if they have FOVs that may overlap). For example, a surveillance camera may be located on a light pole within a festival. The police officer wearing the body-worn camera may be patrolling the festival. The imagery received by the surveillance camera may be used as a proxy to determine the FOV (or potential FOVs) of the body-worn camera worn by the patrolling officer.

In yet a further embodiment of the present invention, a first camera may provide metadata to a second camera (or a remote server) so that the second camera can be used to identify the FOV of the first camera. For example, a body-worn camera may provide metadata to a surveillance camera so that the surveillance camera can be used to identify the FOV of the body-worn camera. Alternatively, a body-worn camera may provide metadata to a server so that the server can be used to identify the FOV of the body-worn camera. In yet a further example a camera embedded in a user's glasses could provide it's FOV to the body worn camera.

In a simple form, the metadata may simply comprise compass directions (e.g., camera pointing at 105 degrees). In a more advanced embodiment, the FOV identified by the metadata will comprise location information along with level information and compass direction and focal length used, such that a more-precise FOV of the body-worn camera may be determined.

The metadata can be collected from a variety of sensors such as location sensors (such as via Global Positioning System (GPS)), gyroscopes, compasses, and/or accelerometers associated with the camera. As described above, the metadata may comprise a current geographic location of a camera (e.g., 42 deg 04′ 03.482343″ lat., 88 deg 03′ 10.443453″ long. 727 feet above sea level), and a compass direction to which the camera is pointing (for example, 270 deg. from north), and a level direction of the camera (e.g., −25 deg. from level). This information can then be passed to a second camera (e.g., a surveillance camera) or server so that the camera's location, direction, and level can be used by the second camera (or server) to determine the body-worn camera's FOV. The second camera can then point to the FOV and determine what exists within the body-worn camera's FOV. Alternatively, a server can direct the second camera to point to the FOV in order to determine what exists within the body-worn camera's FOV. This information can be used to determine the minimal amount of information needed to identify a person or object.

Regardless of how the FOV (or potential FOVs) of the body-worn camera is determined, an apparatus that exists remote from the body-worn camera can analyze the FOV (or potential FOVs) of the body-worn camera to determine a minimal set of characteristics necessary to identify an object/person within the FOV (or potential FOV) of the body-worn camera. More particularly, once a full set of characteristics that can be used to identify the object/person is obtained or determined by the remote device, the FOV (or potential FOVs) of the body-worn camera is determined. All possible combinations of information in the full set are analyzed to determine if they can be used to uniquely identify the person/object within the FOV (or potential FOVs) of the body-worn camera. In one embodiment, only the combinations of information comprising a least amount of information that can be used by the body-worn camera to identify the object/person within the FOV (or potential FOVs) is sent to the body-worn camera.

So, for example, if the full set of characteristics that can be used to identify the object/person comprises 8 identifiers, then there exists 254 different combinations of those identifiers that may potentially be sent to the body-worn camera (8!/[(1!*(8-1)!]+8!/[2!*(8-2)!]+8!/[3!*(8-3)!]+ . . . +8!/[8!*(8-8)!]=8+28+56+70+56+28+8=254). Each of the 254 different combinations of identifiers may be analyzed to determine the combinations that may be used to identify the object/person within in the body-worn camera's FOV (or potential FOVs). A set with the minimal number of members is then sent to the body-worn camera to be used for identification.

Expanding on the above, assume the full set of characteristics that can be used to identify a person comprises a set {male, blue shirt, boots, stocking cap, biometric measurement #1, biometric measurement #2, . , biometric measurement #N}, where biometric measurements comprise any measurement or ratio of measurements of biometric features of an individual (for example, a ratio of eye separation, distance to eye/chin distance, height etc). From the FOV of a body-worn camera, an apparatus determines that only one male wearing a blue short exists within the FOV, the apparatus only needs to send the minimal set {blue shirt, male} to uniquely identify the person.

Expanding on the above example, there may comprise instances where multiple two-element subsets may be used to identify the person (e.g., {over six foot, male} and {biometric measurement #2, blue shirt}). In this situation, there may exist a hierarchy of preferred characteristics that will be utilized for identification prior to other characteristics being used. So, for example, a blue shirt may be quite easily identifiable, however, biometric measurement #2 may not be easily identifiable. In this situation, a “score” of the minimal set may be used to determine what sub-set to utilize for identification. Each possible characteristic may be assigned a numerical value, and the values of each element of the subset may be added together to produce the score. The subset with, for example, the lowest score may be sent to the body-worn camera.

Consider the situation where both subsets {height over six foot, male} and {biometric measurement #2, blue shirt} can be used to uniquely identify an individual within a FOV (or potential FOV) of a body-worn camera. Assume that each characteristic is assigned a numerical value as follows: height=5, gender=2, biometric measurement #2=8, and shirt color=1. Then the score for {height, over six foot, male} =7, and the score for {biometric measurement #2, blue shirt}=9. If the lowest scored subset is utilized for identification, then {height over six foot, male} will be transmitted to the body-worn camera for use in identifying the suspect.

The “scores” given to each element within a subset may be based on how computationally complex a video analysis engine will need to be in order for the body-worn camera to identify the element. A recognition engine/video analysis engine (VAE) comprises a software engine that analyzes analog and/or digital video. The particular software engine being used can vary based on what element is being searched for. In one embodiment, various video-analysis engines are stored in storage, each serving to identify a particular element (height, gender, shirt color, biometric measurement #2, . . . , etc.). A more computationally complex VAE needed to identify a particular element will result in a higher numerical value given to that element.

Using the software engine, body-worn camera is able to “watch” video and detect/identify pre-selected objects (e.g., blue shirt). The video-analysis engine may contain any of several object detectors as defined by the software engine. Each object detector “watches” the video for a particular type of object. For example, “shirt color” object detector software may be utilized to detect a color of a shirt, while a gender detection software may be utilized to detect if an individual is male or female.

As discussed above, once the first minimal set of characteristics has been determined, the first camera can use the characteristics to assist with the detection of the object or person. Similarly the second minimal set of characteristics can be used by the second camera. One or both of the first minimal set of characteristics and the second minimal set of characteristics may also be useful to a user associated with one or both of the first camera or second camera. Thus one or both of the minimal set of characteristics could be audibly output so that the user can also look for the object or person.

In a second embodiment of the present invention, a camera may be used as a proxy as to what an individual sees. For example, if the second camera is a forward facing body worn camera, the FOV of the camera will be similar to an associated user looking forward. A minimal set of identifiers may be determined as described above for a user's FOV, and an audible output of the minimum set of identifiers may be “spoken” to the user. For example, assume a body-worn camera identifies a suspect and determines a set of characteristics that may identify the suspect. The body-worn camera may then determine a minimal set of characteristics needed to identify the suspect, and output the minimal set of characteristics to the user in an audible fashion.

The minimal set of characteristics may be based on the FOV of the body worn camera with the knowledge that it will be similar to that of the user. Alternatively, the body worn camera could estimate or determine the FOV of the user based on user parameters such as current head position, eye gaze information, height of the user etc. These parameters could be obtained from external sensors that are part of a Personal Area Network (PAN), or based on video analysis from proximate cameras. Alternatively, the body worn camera may be a 360 degree camera and have a FOV that includes the user. The body worn camera could then determine these parameters using known video analytics. Alternatively, the user could wear smart glasses containing a forward looking camera. The FOV of the camera in the glasses would be a reasonable representation of the FOV of the user. Metadata containing the FOV of the glasses could be transmitted to the body worn camera to assist with determining the minimal set of characteristics based on the FOV of the user.

Expanding on the above, assume that a set of characteristics are determined by a camera (or provided to the camera by an external entity). If the camera identifies the individual using the set of characteristics, the camera may determine a minimal set of characteristics (as described above), and then audibly provide the minimal set of characteristics to the user. So, for example, an output might comprise something like, “suspect wearing a blue shirt”, “lost child detected wearing a red hat”, “suspect detected male, over six foot, blue shirt”, . . . , etc.

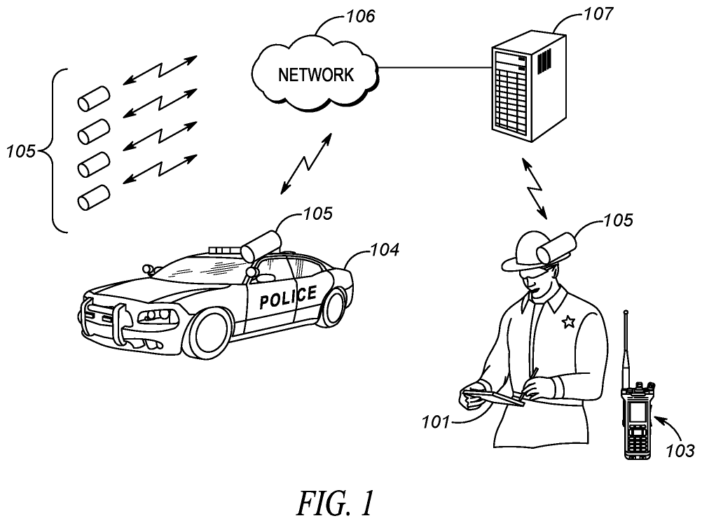

Turning now to the drawings wherein like numerals designate like components, FIG. 1 illustrates a general operational environment for a public-safety officer. As shown in FIG. 1, multiple cameras 105 are providing a live video feed and/or still images of objects within their FOV. Cameras 105 may be embodied in various physical system elements, including a standalone device, or as functionality in a Network Video Recording device (NVR), a Physical Security Information Management (PSIM) device, a camera bundled within a smartphone device, a camera worn by officer 101, a camera mounted on a public-safety vehicle 104, a pole-mounted surveillance camera, . . . , etc. Furthermore, the cameras 105 could be mounted on any mobile entity such as a vehicle (terrestrial, aerial or marine) or mobile user 101 (such as a body-worn camera mounted on a user's helmet or lapel) or a mobile robot.

Public-safety officers 101 are usually associated with radio 103 that is equipped with a graphical user interface. Radio 103 can be any portable electronic device, including but not limited to a standalone display or monitor, a handheld computer, a tablet computer, a mobile phone, a police radio, a media player, a personal digital assistant (PDA), or the like, including a combination of two or more of these objects.

During operation, cameras 105 continuously capture a real-time video stream. Along with the video steam, cameras 105 may also capture metadata that includes the geographic location of a particular camera 105 (e.g., GPS coordinates) and an “absolute direction” (such as N, W, E, S) associated with each video stream during the course of operation. Additional information such as a camera resolution, focal length, camera resolution and type of camera, camera view angle, and/or time of the day may be captured as metadata.

It should be noted that the direction of the camera refers to the direction of the camera's field of view in which camera 105 is recording. Thus, the metadata may provide information such as, but not limited to the fact that camera 105 is located at a particular location and capturing a particular identified field of view (FOV) at a particular time, with a particular camera type, and/or focal length. In a simple form, a camera captures video, still images, or thermal images of a FOV. The FOV identified in the metadata may simply comprises compass directions (e.g., camera pointing at 105 degrees). In a more advanced embodiment, the FOV identified in the metadata will comprise location information along with level information and compass direction and focal length used, such that a field of view may be determined.

The metadata as described above can be collected from a variety of sensors (not shown) such as location sensors (such as via Global Positioning System (GPS)), gyroscopes, compasses, and/or accelerometers associated with the camera. The metadata may also be indirectly derived from a Pan-Tilt-Zoom functionality of the camera. Furthermore, the aforementioned sensors may either be directly associated with the camera or associated with the mobile entity with which the camera is coupled such as a smartphone, the mobile user, a vehicle, or a robot.

Server 107 is provided, and preferably located within a dispatch center (not shown). In one embodiment of the present invention, server 107 may act as an apparatus determining a minimal set of characteristics necessary for identification. In another embodiment of the present invention, any camera 105 may act as the apparatus determining a minimal set of characteristics necessary for identification.

As can be readily understood by those skilled in the art, the transmission of video and the supporting metadata may traverse one or more communication networks 106 such as one or more of wired and/or wireless networks. Furthermore, video and metadata may first be transmitted to server 107 from a first camera. Server 107 may post-process the video and metadata feed and then transmit the feed to one or more cameras 105. Note that server 107 may record and keep a copy of the video and metadata feed for future use for example to transmit the recorded video and metadata to an investigator for investigative purposes at a later time.

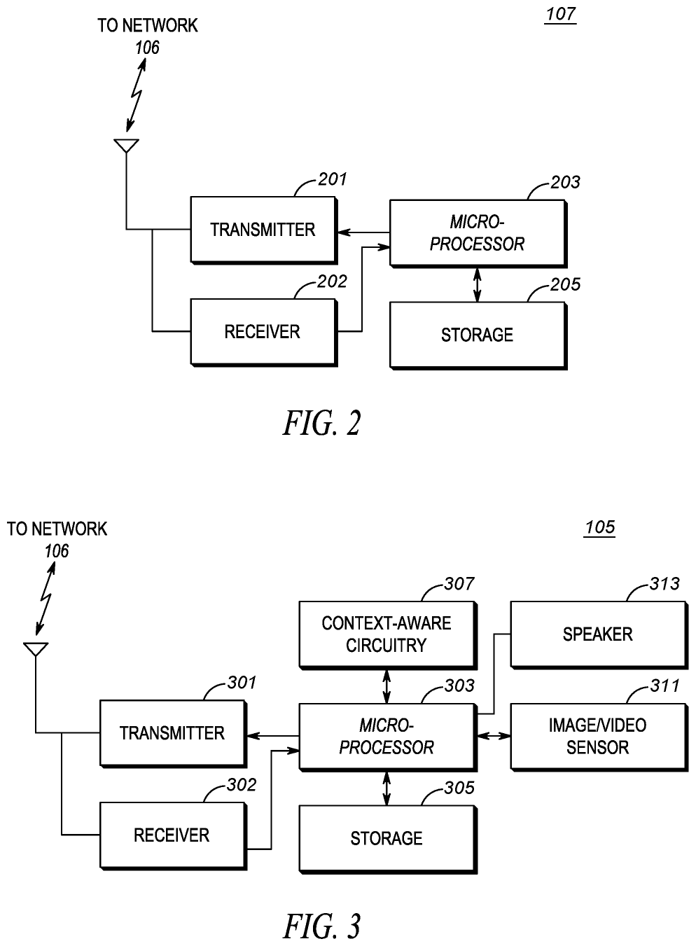

FIG. 2 is a block diagram of the server of FIG. 1. Server 107 typically comprises processor or microprocessor controller 203 that is communicatively coupled with various system components, including transmitter 201, receiver 202, and general storage component 205. Only a limited number of system elements are shown for ease of illustration; but additional such elements may be included in the server 107.

Processing device 203 may be partially implemented in hardware and, thereby, programmed with software or firmware logic or code for performing functionality described. The processing device 203 may be completely implemented in hardware, for example, as a state machine or ASIC (application specific integrated circuit).

Storage 205 can include short-term and/or long-term storage (e.g., RAM, and/or ROM) and serves to store various information that can be used to determine a minimal set of characteristics for each camera 105 to identify an object/suspect. For example, storage 205 may store information related to the FOVs of all cameras within the system. Storage 205 may further store software or firmware for programming the processing device 203 with the logic or code that can be used to perform its functionality.

Transmitter 201 and receiver 202 are common circuitry known in the art for communication utilizing a well known communication protocol, and serve as means for transmitting and receiving messages. For example, receiver 202 and transmitter 201 may be well known long-range transceivers that utilize the Apco 25 (Project 25) communication system protocol. Other possible transmitters and receivers include, IEEE 802.11 communication system protocol, transceivers utilizing Bluetooth, HyperLAN protocols, or any other communication system protocol. Server 107 may contain multiple transmitters and receivers, to support multiple communications protocols.

When server 107 is performing the task of determining a minimal set of characteristics for a particular camera 105 (e.g., a body-worn camera), server 107 will need to obtain a first video feed or image of the object/person needing to be identified, along with the FOV of the particular camera 105 that will be provided the minimal set. This information may be obtained via receiver 202. More particularly, a first camera 105 may be providing a video feed of the object/subject to be identified. Logic circuitry 203 will determine a first set (full set) of characteristics that may be used to identify the object/subject.

Logic circuitry 203 will need to determine the minimal set of characteristics necessary to identify the object/subject. As discussed, the minimal set of characteristics is based on the FOV of the camera to which the characteristics will be provided. In other words, a first camera may be provided a first minimal set of characteristics, while a second camera may be provided a second minimal set of characteristics. The minimal set of characteristics comprises a subset of the first set (full set) of characteristics which can be used to uniquely identify the object/subject.

As discussed above, there may be several ways that server 107 may receive the current (or potential) FOV for a camera. In one embodiment, the actual feed for the camera is provided to receiver 202 and ultimately to logic circuitry 203. In another embodiment of the present invention, a feed from a co-located camera (co-located with the camera to receive the minimal set) may be received by receiver 202 and provided to logic circuitry 203. The feed from the co-located camera may be a proxy for the camera to receive the minimal set of characteristics. In other words, a feed from a second camera may serve as a proxy FOV for a first camera.

In yet another embodiment of the present invention, metadata is used to determine a FOV for a camera to receive the minimal set of characteristics. As described, the metadata may describe an actual location of the FOV, a second camera may then be directed to the actual location of the FOV, and again, the second camera may be used as a proxy for the first camera.

Regardless of the technique utilized to determine what lies in the FOV of the camera that will receive the minimal set of characteristics, logic circuitry 203 uses the FOV to determine the minimal set of characteristics necessary. More particularly, the FOV will be used to determine what lies within the FOV. Differences between objects/subjects that lie in the FOV and the object/subject to be identified are determined, and a minimal set of characteristics are determined that will identify the object/subject if the object/subject lied within the FOV.

FIG. 3 is a block diagram of camera 105 that may be used to provide a minimal set of characteristics to another camera or person in order to identify a person or object. Camera 105 can also be configured to provide a minimal set of characteristics needed to identify a person or object. Camera 105 typically comprises processor 303 that is communicatively coupled with various system components, including transmitter 301, receiver 302, general storage component 305, context-aware circuitry 307, speaker 313, and a sensor 311. Only a limited number of system elements are shown for ease of illustration; but additional elements may be included in the user device 103.

Processing device 303 may be partially implemented in hardware and, thereby, programmed with software or firmware logic or code for performing functionality described herein. The processing device 303 may be completely implemented in hardware, for example, as a state machine or ASIC (application specific integrated circuit). Storage 305 can include short-term and/or long-term storage of various information that can be used for storing FOV information for other cameras. Storage 305 may further store VAEs along with software or firmware for programming the processing device 303 with the logic or code that can be used to perform its functionality.

Sensor 311 electronically captures a sequence of video frames (i.e., a sequence of one or more still images), with optional accompanying audio, in a digital format. The images or video captured by the image/video sensor 311 may be stored in the storage component 305.

Context-aware circuitry 307 preferably comprises a GPS receiver, level sensor, and a compass that identifies a location and direction of sensor 311. For example, circuitry 307 may determine that camera 105 is located at a particular latitude and longitude, and pointing North.

Transmitter 301 and receiver 302 are common circuitry known in the art for communication utilizing a well known communication protocol, and serve as means for transmitting and receiving messages. For example, receiver 302 and transmitter 301 may be well known long-range transceivers that utilize the Apco 25 (Project 25) communication system protocol. Other possible transmitters and receivers include, IEEE 802.11 communication system protocol, transceivers utilizing Bluetooth, HyperLAN protocols, or any other communication system protocol. User device 103 may contain multiple transmitters and receivers, to support multiple communications protocols.

Finally, speaker 313 is used to output any audible warning to the operator about suspect characteristics. In other words, speaker is used to output an audible identification of the minimal set of characteristics needed to identify a person or an object.

In an embodiment, camera 105 may provide a second camera with FOV information, and in return receive a minimal set of characteristics needed to identify a person or object. The minimal set of characteristics may be output audibly via speaker 313. During this process, context-aware circuitry 307 provides logic circuitry 303 with a current FOV of sensor 311. This information is then transmitted via transmitter 301 to a second camera 105, or alternatively, to server 107. In response, receiver 302 receives a minimal set of characteristics needed to identify a person or object. Logic circuitry 303 may then access storage 305 and retrieve an appropriate VAE, which is based on the elements contained within the minimal set.

In a further embodiment, camera 105 may calculate the minimal set of characteristics based on a second camera's FOV, and transmit the minimal set of characteristics to the second camera. During this process, logic circuitry 303 determines the full set of characteristics needed to identify a person or object. As discussed above, logic circuitry 303 may receive this information from server 107 via receiver 302, or alternatively, may detect a suspicious person or object and determine the full set of characteristics, and may provide the minimal set of characteristics to other cameras based on the other cameras FOV.

Logic circuitry 203 will need to determine the minimal set of characteristics necessary to identify the object/subject. As discussed, the minimal set of characteristics is based on the FOV of the camera to which the characteristics will be provided. In other words, a first camera may be provided a first minimal set of characteristics, while a second camera may be provided a second minimal set of characteristics. The minimal set of characteristics comprises a subset of the full set of characteristics which can be used to uniquely identify the object/subject.

As discussed above, there may be several ways that camera 105 may receive the current (or potential) FOV from another camera. In one embodiment, the actual feed for the camera is provided to receiver 302 and ultimately to logic circuitry 303. In another embodiment of the present invention, where cameras are co-located, a feed from sensor 311 may be used as a proxy for a second camera. In yet another embodiment of the present invention, metadata is used to determine a FOV for a second camera that is to receive the minimal set of characteristics. As described, the metadata may describe an actual location of the FOV, sensor 311 may then be directed to the actual location of the FOV, and again, sensor 311 may be used as a proxy for the second camera.

Regardless of the technique utilized to determine what lies in the FOV of the camera that will receive the minimal set of characteristics, logic circuitry 303 uses the FOV to determine the minimal set of characteristics necessary. More particularly, the FOV will be used to determine what lies within the FOV. Differences between objects/subjects that lie in the FOV and the object/subject to be identified are determined, and a minimal set of characteristics are determined that will identify the object/subject if the object/subject lied within the FOV.

As discussed above, the current FOV of the camera may serve as a proxy for a user's FOV. When this is the case, logic circuitry 303 will identify the minimal set of characteristics needed to identify the person or object within its own FOV, and then output the minimal set to speaker 313. Logic circuitry 303 may be provided with the minimal set of characteristics, provided with the full set of characteristics and then determine the minimal set of characteristics, or determine the full set of characteristics and the minimal set of characteristics.

As discussed above, the minimal set of characteristics depends upon the FOV of the camera being provided the minimal set of characteristics. With this in mind, both the apparatus shown in FIG. 2 and the apparatus shown in FIG. 3 may provide multiple sets of minimal characteristics to multiple devices. Both FIG. 2 and FIG. 3 provide the circuitry necessary to accomplish this. More particularly, both FIG. 2 and FIG. 3 provide for an apparatus comprising a receiver configured to receive information that identifies a first field of view (FOV) from a first camera and a second FOV from a second camera. Logic circuitry is provided that is configured to access a set of characteristics that identifies a person or object, and determine a first minimal set of characteristics necessary to identify the person or object within the first FOV from the first camera. As discussed, the first minimal set of characteristics comprises a subset of the set of characteristics.

When communicating with multiple cameras, the logic circuitry is also configured to determine a second minimal set of characteristics necessary to identify the person or object within the second FOV from the second camera. The second minimal set of characteristics comprises a subset of the set of characteristics and is different than the first minimal set of characteristics.

A transmitter is provided and configured to transmit the first minimal set of characteristics to the first camera and transmitting the second minimal set of characteristics to the second camera.

As discussed above, the first minimal set of characteristics comprises a minimum number of characteristics from the set of characteristics that can be used to uniquely identify the person or object within the first FOV, and the second minimal set of characteristics comprises a minimum number of characteristics from the set of characteristics that can be used to uniquely identify the person or object within the second FOV.

Additionally, the number of characteristics sent to each camera may vary. Thus, the first minimal set of characteristics may comprise a first number of characteristics from the set of characteristics that can be used to uniquely identify the person or object within the first FOV, and the second minimal set of characteristics may comprise a second number of characteristics from the set of characteristics that can be used to uniquely identify the person or object within the second FOV.

As discussed, the information that identifies a first FOV may comprise a video feed from the first camera, and the information that identifies a second FOV may comprise a video feed from the second camera.

As discussed the information that identifies a first FOV may comprise metadata from the first camera, and wherein the information that identifies a second FOV may comprise metadata from the second camera.

The apparatus of FIG. 3 further comprises an image/video sensor that may be configured to point to the first FOV and the second FOV based on the metadata from the first camera and the metadata from the second camera. When this is the case, logic circuitry determines the first minimal set of characteristics necessary to identify the person or object within the first FOV by pointing image/video sensor to the first FOV to determine what lies in the first FOV. The logic circuitry may also determine the second minimal set of characteristics necessary to identify the person or object within the second FOV by pointing the image/video sensor to the second FOV to determine what lies in the second FOV.

As discussed above, the first minimal set of characteristics may be determined by the logic circuitry determining a score for every characteristic within the set of characteristics, determining every combination of characteristics possible from the set of characteristics, determining combinations of characteristics from every combination of characteristics possible that uniquely identifies the person or object within the first FOV, where the first minimal set of characteristics comprises a combination of characteristics from every combination of characteristics possible that uniquely identifies the person or object within the first FOV having a lowest score.

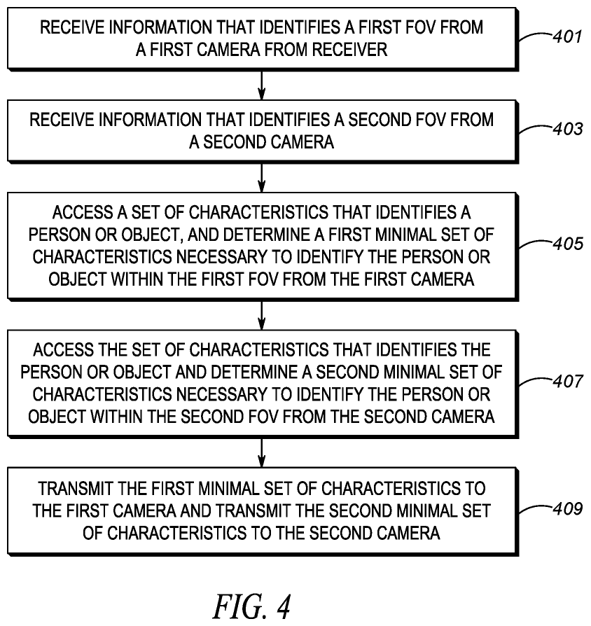

FIG. 4 is a flow chart showing operation of the apparatuses shown in FIG. 2 and FIG. 3. More particularly, the logic flow in FIG. 4 shows those steps (not all necessary) for either server 107 or a remote camera 105 to provide a minimal set of characteristics to multiple cameras having multiple FOVs. The logic flow begins at step 401 where logic circuitry 203/303 receives information that identifies a first FOV from a first camera from receiver 202/302. At step 403 logic circuitry 203/303 also receives information that identifies a second FOV from a second camera.

As discussed above, the first and the second camera are remote from server 107 and camera 105 shown in FIG. 3.

At step 405, logic circuitry 203/303 accesses a set of characteristics that identifies a person or object, and determines a first minimal set of characteristics necessary to identify the person or object within the first FOV from the first camera. As discussed above, the first minimal set of characteristics comprises a subset of the set of characteristics.

At step 407, logic circuitry 203/303 accesses the set of characteristics that identifies the person or object and determining a second minimal set of characteristics necessary to identify the person or object within the second FOV from the second camera.

As discussed above, the second minimal set of characteristics comprises a subset of the set of characteristics that is different than the first minimal set of characteristics. Additionally, the set of characteristics that identifies the person or object may be obtained from storage 205/305, or determined by logic circuitry 203/303.

At step 409, transmitter 201/301 is used for transmitting the first minimal set of characteristics to the first camera and transmitting the second minimal set of characteristics to the second camera.

As discussed above, in one embodiment, the first minimal set of characteristics comprises a minimum number of characteristics from the set of characteristics that can be used to uniquely identify the person or object within the first FOV, and the second minimal set of characteristics comprises a minimum number of characteristics from the set of characteristics that can be used to uniquely identify the person or object within the second FOV. In other words, in this particular embodiment, both the first and the second minimal sets of characteristics will comprise a set having a minimum number of characteristics that can be utilized to uniquely identify the person or object. So, for example, if a first set of characteristics that can uniquely identify the person or object comprises five characteristics, and a second set of characteristics that can uniquely identify the person or object comprises four characteristics, then the second set of characteristics will be used as the minimal set of characteristics.

It should be noted that because each FOV is unique, the first minimal set of characteristics may comprise a first number of characteristics from the set of characteristics that can be used to uniquely identify the person or object within the first FOV, and the second minimal set of may comprise a second number of characteristics from the set of characteristics that can be used to uniquely identify the person or object within the second FOV.

Also, as discussed above, the information that identifies the first FOV may comprise a video feed from the first camera, and the information that identifies a second FOV may comprise a video feed from the second camera. Alternatively, the information that identifies the first FOV may comprise metadata from the first camera, and the information that identifies the second FOV may comprise metadata from the second camera.

When the information that identifies the first FOV comprises metadata from the first camera, and the information that identifies the second FOV comprises metadata from the second camera, then a third camera comprising a video/image sensor may be configured to point to the first FOV and the second FOV based on the metadata from the first camera and the metadata from the second camera. The logic circuitry may then determine the first minimal set of characteristics necessary to identify the person or object within the first FOV by pointing third camera to the first FOV to determine what lies in the first FOV. The logic circuitry may also determine the second minimal set of characteristics necessary to identify the person or object within the second FOV from by pointing the third camera to the second FOV to determine what lies in the second FOV.

As discussed above, the minimal set of characteristics may be based on a complexity of using those characteristics to identify the object or person. When this is the case, every characteristic within the set of characteristics is assigned a score. This may be done by the logic circuitry, or simply stored in memory. The logic circuitry may then determine every combination of characteristics possible from the set of characteristics, and determine combinations of characteristics from every combination of characteristics possible that uniquely identifies the person or object within the first FOV. The minimal set of characteristics will then comprise a combination of characteristics from every combination of characteristics possible that uniquely identifies the person or object within the first FOV having a lowest score.

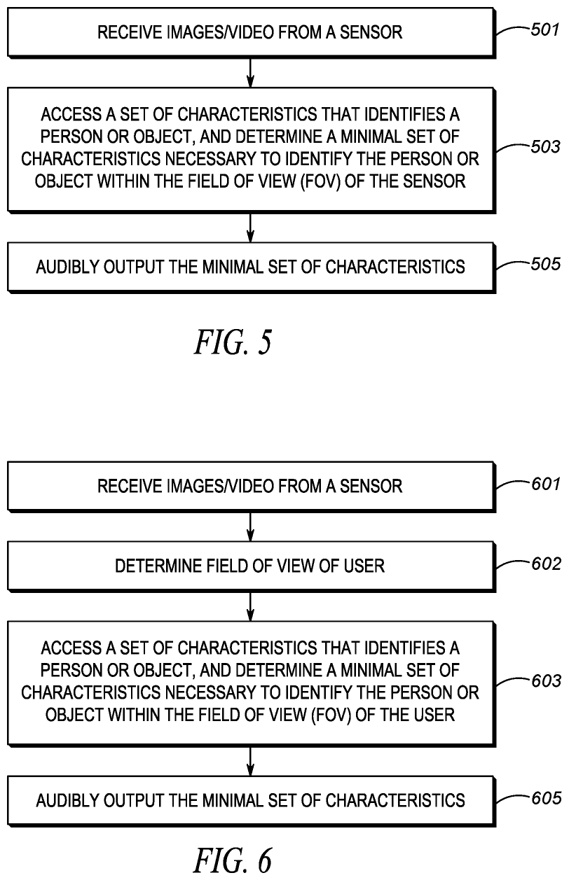

As discussed above, a device can serve as a proxy for what a user can see and then audibly provide a minimum set of characteristics to a user in order to identify an object or person. FIG. 5 is a flow chart showing operation of the apparatus of FIG. 3 performing an audible notification of a minimal set of characteristics. The logic flow begins at step 501 where logic circuitry 303 receives images/video from sensor 311. At step 503, logic circuitry 303 then accesses a set of characteristics that identifies a person or object, and determines a minimal set of characteristics necessary to identify the person or object within the field of view (FOV) of sensor 311, wherein the minimal set of characteristics comprises a subset of the set of characteristics. Finally, at step 505, logic circuitry 303 causes speaker 313 to audibly output the minimal set of characteristics.

In an alternative embodiment to that shown in FIG. 5. a device can estimate or determine the actual field of view of a user associated with a camera, or sensor, and then audibly provide a minimum set of characteristics to the user. This will help with the user quickly identifying the object or person of interest. FIG. 6. is a flow chart showing operation of the apparatus of FIG. 3 performing an audible notification of a minimal set of characteristics in accordance with this alternative embodiment. The logic flow begins at step 601 where logic circuitry 303 receives images/video from sensor 311. At step 602, logic circuitry 303 determines the FOV of the associated user. As discussed above the determination of the FOV of the associated user can be based on user parameters such as current head position, eye gaze information, height of the user etc. These parameters could be obtained from external sensors that are part of a Personal Area Network (PAN), or based on video analysis from proximate cameras. Alternatively, the body worn camera may be a 360-degree camera and have a FOV that includes the user. The body worn camera could then determine these parameters using known video analytics.

At step 603, logic circuitry 303 then accesses a set of characteristics that identifies a person or object, and determines a minimal set of characteristics necessary to identify the person or object within the FOV of the associated user, wherein the minimal set of characteristics comprises a subset of the set of characteristics. Finally, at step 605, logic circuitry 303 causes speaker 313 to audibly output the minimal set of characteristics.

As discussed, the minimal set of characteristics may comprise a minimum number of characteristics from the set of characteristics that can be used to uniquely identify the person or object within the FOV.

As discussed above, the step of determining the minimal set of characteristics comprises the steps of assigning every characteristic within the set of characteristics a score, determining every combination of characteristics possible from the set of characteristics, and determining combinations of characteristics from every combination of characteristics possible that uniquely identifies the person or object within the FOV. The minimal set of characteristics comprises a combination of characteristics from every combination of characteristics possible that uniquely identifies the person or object within the first FOV having a lowest score.

In the foregoing specification, specific embodiments have been described. However, one of ordinary skill in the art appreciates that various modifications and changes can be made without departing from the scope of the invention as set forth in the claims below. All such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus comprising:
a receiver configured to receive information that identifies a first field of view (FOV) from a first camera and a second FOV from a second camera;
logic circuitry configured to access a set of characteristics that identifies a person or object, and determine a first minimal set of characteristics necessary to identify the person or object within the first FOV from the first camera, wherein the first minimal set of characteristics comprises a subset of the set of characteristics, the logic circuitry also configured to determine a second minimal set of characteristics necessary to identify the person or object within the second FOV from the second camera, wherein the second minimal set of characteristics comprises a subset of the set of characteristics and is different than the first minimal set of characteristics; and
a transmitter configured to transmit the second minimal set of characteristics to the second camera.

2. The apparatus of claim 1 where the transmitter is further configured to transmit the first minimal set of characteristics to the first camera

3. The apparatus of claim 1 wherein the first minimal set of characteristics comprises a minimum number of characteristics from the set of characteristics that can be used to uniquely identify the person or object within the first FOV, and the second minimal set of characteristics comprises a minimum number of characteristics from the set of characteristics that can be used to uniquely identify the person or object within the second FOV.

4. The apparatus of claim 1 wherein the first minimal set of characteristics comprises a first number of characteristics from the set of characteristics that can be used to uniquely identify the person or object within the first FOV, and the second minimal set of characteristics comprises a second number of characteristics from the set of characteristics that can be used to uniquely identify the person or object within the second FOV.

5. The apparatus of claim 1 wherein the information that identifies the first FOV comprises a video feed from the first camera, and wherein the information that identifies the second FOV comprises a video feed from the second camera.

6. The apparatus of claim 1 wherein the information that identifies the first FOV comprises metadata from the first camera, and wherein the information that identifies the second FOV comprises metadata from the second camera.

7. The apparatus of claim 1 further comprising a speaker, wherein the speaker is configured to audibly output at least one of the first minimal set of characteristics and the second minimal set of characteristics.

8. The apparatus of claim 1 where the second minimal set of characteristics is dependent on a determined field of view of a user associated with the second camera.

9. The apparatus of claim 1 further comprising:
an image/video sensor;
wherein the information that identifies the first FOV comprises metadata from the first camera, and wherein the information that identifies the second FOV comprises metadata from the second camera;
wherein the image/video sensor is configured to point to the first FOV and the second FOV based on the metadata from the first camera and the metadata from the second camera;
wherein the logic circuitry determines the first minimal set of characteristics necessary to identify the person or object within the first FOV by pointing image/video sensor to the first FOV to determine what lies in the first FOV; and
wherein the logic circuitry determines the second minimal set of characteristics necessary to identify the person or object within the second FOV by pointing the image/video sensor to the second FOV to determine what lies in the second FOV.

10. The apparatus of claim 1 wherein the first minimal set of characteristics are determined by the logic circuitry:
determining a score for every characteristic within the set of characteristics;
determining every combination of characteristics possible from the set of characteristics;
determining combinations of characteristics from every combination of characteristics possible that uniquely identifies the person or object within the first FOV; and
wherein the first minimal set of characteristics comprises a combination of characteristics from every combination of characteristics possible that uniquely identifies the person or object within the first FOV having a lowest score.

11. A method comprising the steps of:
receiving information that identifies a first FOV from a first camera;
receiving information that identifies a second FOV from a second camera;
accessing a set of characteristics that identifies a person or object, and determining a first minimal set of characteristics necessary to identify the person or object within the first FOV from the first camera, wherein the first minimal set of characteristics comprises a subset of the set of characteristics;
accessing the set of characteristics that identifies the person or object and determining a second minimal set of characteristics necessary to identify the person or object within the second FOV from the second camera, wherein the second minimal set of characteristics comprises a subset of the set of characteristics that is different than the first minimal set of characteristics; and
transmitting at least one of
the first minimal set of characteristics to the first camera; or
the second minimal set of characteristics to the second camera.

12. The method of claim 11 wherein the first minimal set of characteristics comprises a minimum number of characteristics from the set of characteristics that can be used to uniquely identify the person or object within the first FOV, and the second minimal set of characteristics comprises a minimum number of characteristics from the set of characteristics that can be used to uniquely identify the person or object within the second FOV.

13. The method of claim 11 wherein the first minimal set of characteristics comprises a first number of characteristics from the set of characteristics that can be used to uniquely identify the person or object within the first FOV, and the second minimal set of characteristics comprises a second number of characteristics from the set of characteristics that can be used to uniquely identify the person or object within the second FOV.

14. The method of claim 11 wherein the information that identifies the first FOV comprises a video feed from the first camera, and wherein the information that identifies the second FOV comprises a video feed from the second camera.

15. The method of claim 11 wherein the information that identifies the first FOV comprises metadata from the first camera, and wherein the information that identifies the second FOV comprises metadata from the second camera.

16. The method of claim 11:
wherein the information that identifies the first FOV comprises metadata from the first camera, and wherein the information that identifies the second FOV comprises metadata from the second camera; and
further comprising the step of pointing a third camera at the first FOV and the second FOV based on the metadata from the first camera and the metadata from the second camera;
wherein the first minimal set of characteristics necessary to identify the person or object within the first FOV is determined by pointing third camera to the first FOV to determine what lies in the first FOV; and
wherein the second minimal set of characteristics necessary to identify the person or object within the second FOV from is determined by pointing the third camera to the second FOV to determine what lies in the second FOV.

17. The method of claim 11 wherein the step of determining the first minimal set of characteristics comprises the steps of:
assigning every characteristic within the set of characteristics a score;
determining every combination of characteristics possible from the set of characteristics;
determining combinations of characteristics from every combination of characteristics possible that uniquely identifies the person or object within the first FOV;
wherein the first minimal set of characteristics comprises a combination of characteristics from every combination of characteristics possible that uniquely identifies the person or object within the first FOV having a lowest score.

18. The method of claim 11 further comprising audibly outputting at least one of the first minimal set of characteristics and the second minimal set of characteristics

19. A method comprising the steps of:
receiving images/video from a sensor;
determining the field of view of a user associated with the sensor;
accessing a set of characteristics that identifies a person or object, and determining a minimal set of characteristics necessary to identify the person or object within the determined field of view (FOV) of the user, wherein the minimal set of characteristics comprises a subset of the set of characteristics;
audibly outputting the minimal set of characteristics.

20. The method of claim 19 wherein the step of determining the minimal set of characteristics comprises the steps of:
assigning every characteristic within the set of characteristics a score;
determining every combination of characteristics possible from the set of characteristics;
determining combinations of characteristics from every combination of characteristics possible that uniquely identifies the person or object within the FOV; and
wherein the minimal set of characteristics comprises a combination of characteristics from every combination of characteristics possible that uniquely identifies the person or object within the first FOV having a lowest score.
